(19) United States
(12) Patent Application Publication
(10) Pub. No.: US 2001/0038738 A1
(43) Pub. Date: Nov. 8, 2001

(54) Ground wire for transmission system

(76) Inventors: Hiroji Akasaka, Rimouski (CA); Michel Huot, Rimouski (CA); Takashi Shinohara, Rimouski (CA); Tarlochan Singh, Pickering (CA); Carlton Choo-Wing, Pickering (CA); Tewfik Schehade, Toronto (CA)

Correspondence Address: Fasken Martineau DuMoulin LLP, 4200 Toronto Dominion Bank Tower, Box 20, Toronto-Dominion Center, Toronto, ON, M5K 1N6, CA

(21) Appl. No.: 09/761,822

(22) Filed: Jan. 18, 2001

(30) Foreign Application Priority Data
Feb. 3, 2000 (CA) 2,297,877

(51) Int. Cl. G02B 6/44

(52) U.S. Cl. 385/101; 385/109

(57) ABSTRACT

A ground wire for a power transmission system has a plastic tube to carry a bundle optical fibers. The plastic tube is clad with a metal strip, preferably aluminium and is supported by a set of wire strands disposed about the tube.

The present invention relates to ground wires for use in the above ground power transmission systems.

Electrical power is distributed through high voltage wires carried above ground on pylons. The wires themselves are not insulated and are connected to the supporting pylons through an insulating structure. A ground wire is carried between the pylons above the conductors to electrically interconnect the pylons and also provide protection to the conductor from disturbances such as lightning and other atmospheric conditions.

The service requirements for the ground wire require it to be electrically conductive as well as self-supporting. In more recent years use has been made of the ground wire to also carry optical fibers so that information can be transmitted along the existing power transmission routes. The wires have been located within a conductive, usually aluminium, tube which in turn is supported by wire strands that provide the tensile strength for the ground wire. Because the ground wire is unsupported between the pylons, it is subject to the normal mechanical forces due to its own inherent weight, wind and other atmospheric conditions such as ice build up. These mechanical forces are imposed on the wire strands and the aluminium tube which in turn transmit the forces through to the optic fibers.

To avoid the possibility of damage to the fibers it is known to arrange the fibers helically on a spacer within the tube. Such an arrangement is relatively expensive due to the need of the additional components and the need to assemble the fiber onto the spacer. As an alternative to a helical spacer it is also known to ensure that an excess length of fiber is provided within the tube so that as the fiber is not subjected to elongation due to the mechanical forces, placed on the tube.

The use of the aluminium tube not only protects the fibers from water but also provides a conduction path between the pylons. However, the aluminium tube is relatively weak in compression and therefore is unable to withstand the radial forces that might be imposed upon it during installation and connection of supporting hardware. Typically the wire is fed to pylons over pulleys and is clamped to the pylons, both of which result in a significant radial loading on the tube. To provide additional mechanical strength it has been proposed to utilize concentric rings of aluminum tube. Typically these wires are steel with an aluminium cladding adjacent the tube and an aluminium alloy as a second band or wires. The increased tensile and radial strengths avoid damage to the tube but at the same time increases the expense of the ground wire.

A further solution that has been proposed is to utilize a stainless steel tube with either a stranded or loose strand of fiber within the tube. The stainless steel tube is surrounded by aluminium alloy or aluminium clad wires to provide the necessary conductivity. However the interface between the aluminium wires and stainless steel tube leads to a galvanic action and corrosion over an extended period.

It is therefore an object of the present invention to provide a ground wire in which the above disadvantages are obviated or mitigated.

In accordance with one aspect of the present invention there is provided a ground wire for use in an above ground power transmission system. The ground wire comprises an elongate plastics tube and at least one fiber optic cable freely moveable within said tube and having an overall length greater than the tube in a free body state. A metal cladding encompasses the tube and a plurality of metal wire strands are disposed about the cladding and extend along the length of said tube.

The provision of a plastic tube to house the optic fibers enables the requisite radial strength to be attained with the metal cladding that is preferably aluminium, providing the necessary conductivity.

According to a further aspect of the present invention there is provided a method of forming a ground wire for use with a power transmission system the method comprises the steps of inserting at least one optical fiber into an elongate plastic tube so as to be freely moveable therein in a relaxed condition and forming a metal cladding about the tube. A plurality of metal strands are then applied to the exterior of the clad tube.

Preferably the metal cladding is an aluminium strip that is rolled about the tube to encompass the plastic tube.

An embodiment of the invention will now be described by way of example only with reference to the accompanying drawings in which:

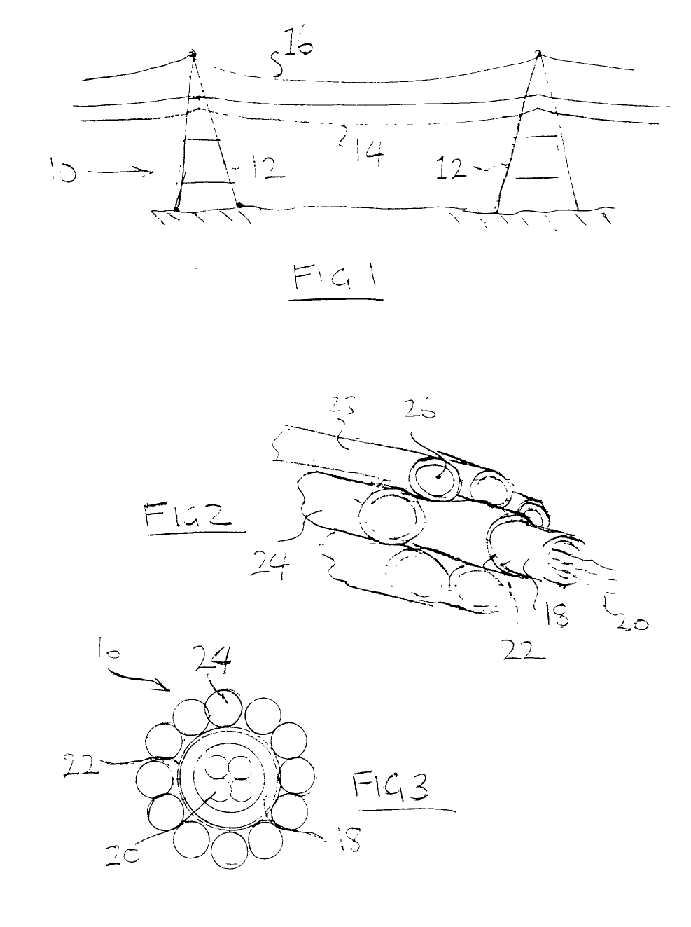

FIG. 1 is a schematic illustration of a power transmission system.

FIG. 2 is a perspective view of a portion of the ground wire used in the power transmission system of FIG. 1.

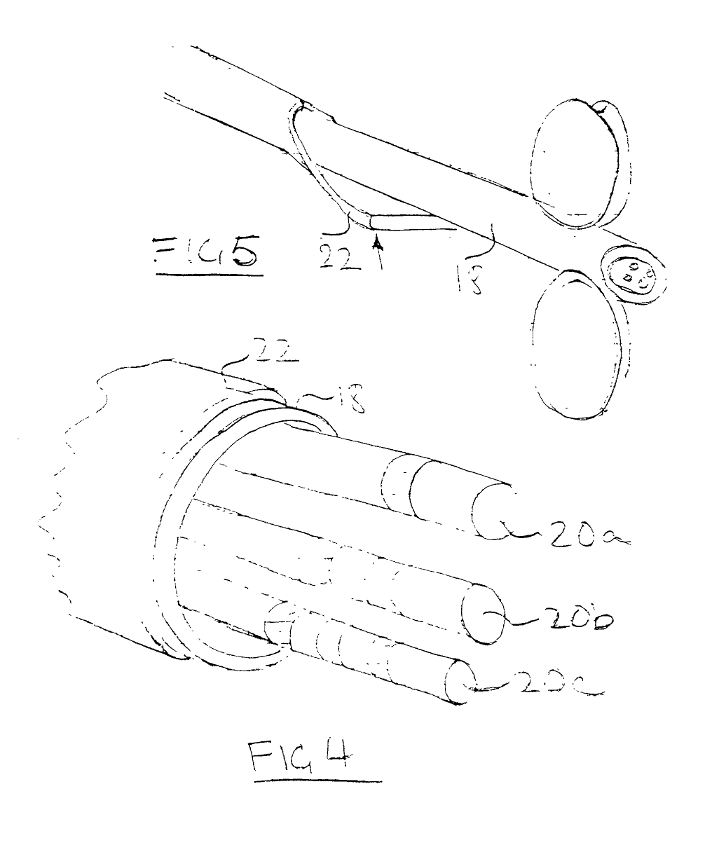

FIG. 3 is an end view of the ground view shown in FIG. 2.

FIG. 4 is an enlarged view of a portion of the wire shown in FIG. 2.

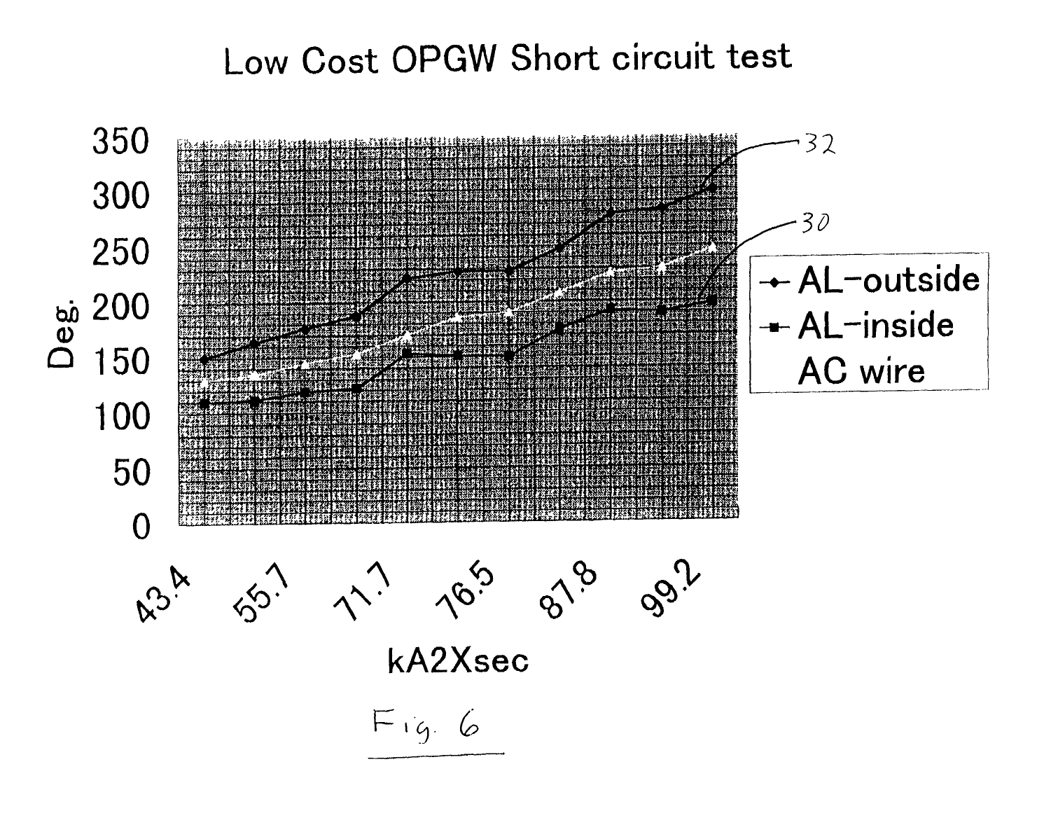

FIG. 5 is a schematic representation of a step in the manufacture in the ground wire of FIG. 2.

FIG. 6 is a graph showing the variation of temperature across a component of the wire shown in FIG. 2.

Referring therefore to FIG. 1, an electrical power transmission system generally indicated at 10 includes a pair of pylons 12 supporting high-tension phase conductors 14. A ground wire 16 extends between the pylons 12 above the conductors 14 between each of the pylons. The ground wire 16 is fixed at each of the pylons 12 by suitable clamps and provides a continuous conductive path between the pylons. The ground wire 16 is shown in more detail in FIGS. 2 and 3 and includes a plastic tube 18 in which are a number of optic fibers 20. The optic fibers are utilized to carry information and typically the tube will carry a significant number of fibers, sometimes upwards of 200. The fibers 20 are loosely located within the tube 18 and in a free body state, have an excess length greater then the length of the tube. In one embodiment this excess length is about 0.1% to 0.3%. In this way the tube 18 may elongate without inducing a corresponding strain upon the fibers 20. As can be seen in FIG. 4, the fibers 20 are marked with ring markings 21 that are applied at periodic intervals. The markings are distinguishable from one another by varying the number and colour of the markings to allow the same fiber to be identified at opposite ends of the wire 16. One of the fibers, 20a is marked periodically with a single ring, another 20b is marked with a double ring and further 20c is marked with a triple ring. The rings may all be the same colour or may be different colours or combinations of colours to allow each fiber to be marked uniquely. In addition, each of the fibers themselves may be different colours to allow each type of marking, 1 ring, 2-ring etc. to identify more than one fiber.

An metal cladding 22 encompasses the tube 18 to provide an electrically conductive path along the tube. The metal cladding is preferably formed from aluminium to provide a high conductivity and closely conforms to the outer wall of the tube 18.

A plurality of wire strands 24 are helically wound around the outside of the tube 22. The strands 24 are typically a steel wire 26 having an aluminium coating 28 and an aluminium alloy strand 27. The strands 24 provide the requisite tensile strength for the tube to span between the pylons 12 and provide similar surface material to the cladding to inhibit galvanic action.

The tube 18 is formed from a plastics material having a relatively high modulus of elongation to permit extension greater than 1% and typically in the order of 6%. The extension can be approximately 10 times the excess length of the fibres 20. The tube is formed from an engineering thermoplastic, typically polycarbonate or polybutylene terephtalate (PBT) or polyethylene terephthalate (PET) or polyethylene napthalate (PEN). In the preferred embodiment tube 18 has a diameter of between 2 and 7 millimeters and a wall thickness of between 0.7 and 2.5 millimeter. The metallic cladding 22 is preferably an aluminium tape rolled about the plastic tube 18 having a thickness in the order of 0.5 to 0.7 millimeters. As shown in FIG. 4, the metallic cladding 22 is wrapped around the plastic tube 18 as the tube is pulled through supporting rollers. The material 22 closely conforms to the outer surface of the tube 18 and provides a continuous seam at opposite edges of the tape. The tape abuts the outer surface of the tube 18 and may be adhered to the wall of the tube by a liquid or solid adhesive 29 applied to the tape or subsequently activated by high frequency or heat.

The wire strands 24 are chosen to be of sufficient diameter and number to provide the tensile strength required for the span between the pylons 12 and may if preferred be arranged in 2 annular bands.

In use, the tube 18 has sufficient radial strength to withstand the radial loads imposed on the cable due to the clamping at the pylon or installation over a pulley. At the same time the plastic tube provides protection for the fibers from water and ice and the excess length of the fibers in the tubes prevents strain being induced in the fibers when the ground wire is subject to mechanical loading.

The tube 18 is also effective to prevent overheating in the event a short circuit is experienced in the strands 24. As can be seen from FIG. 6, the tube 18 is effective to maintain a significant temperature difference of about 100 degrees between the inside temperature 30 and outside temperature 32 of the tube 18 when the outside surface of the tube 18 is subjected to a temperature of 300° C.

It will be appreciated that the dimensions noted above with respect to the preferred embodiment are exemplary only and the individual components may be adjusted to suit the particular mechanical requirements of a given installation.

We claim:

1. A ground wire for use in an above ground power transmission system, said ground wire comprising an elongate plastics tube, at least one fiber optic cable freely moveable within said tube and having an overall length not less than 0.1% greater than said tube in a free body state, a metal cladding encompassing said tube and a plurality of metal wire strands disposed about said cladding and extending along the length of said tube.

2. A ground wire according to claim 1 wherein said cladding and said strands are of similar metal.

3. A ground wire according to claim 2 wherein said cladding is aluminium.

4. A ground wire according to claim 3 wherein said strands are aluminium alloy.

5. A ground wire according to claim 3 wherein said cladding is adhered to said tube.

6. A ground wire according to claim 5 wherein said adhesive is activated by high frequency radiation.

7. A ground wire according to claim 5 wherein said cladding is adhered to said tube by an adhesive selected from the group comprising a liquid adhesive and a solid adhesive.

8. A ground wire according to claim 1 wherein said plastic tube exhibits a longitudinal elasticity greater than 1%.

9. A ground wire according to claim 1 wherein said plastic tube is formed from a plastic selected from the group consisting of polycarbonate and PBT.

10. A ground wire according to claim 1 wherein said plastic tube has a wall thickness sufficient to withstand radial loads imposed thereon during installation.

11. A ground wire according to claim 10 wherein said plastic tube has an outside diameter between 2 mm and 7 mm and a wall thickness of between 0.7 mm and 2.5 mm.

12. A ground wire according to claim 11 wherein said aluminium cladding is coextensive with an outer surface of said tube.

13. A ground wire according to claim 12 wherein said aluminium cladding has a thickness of 0.5 mm to 0.7 mm.

14. A ground wire according to claim 1 wherein said fiber is marked periodically to allow identification thereof at spaced intervals along said wire.

15. A wire according to claim 14 wherein a plurality of fibers is located within said tube and each of said plurality is of a different colour.

16. A method of forming a ground wire for use with a power transmission system, said method comprising the steps of inserting at least one optical fiber into an elongate plastic tube so as to be freely movable therein in a relaxed condition, forming an metal cladding about said tube and apply a plurality of metal strands to the exterior of said clad tube.

17. A method according to claim 16 wherein said metal cladding is formed about said tube by rolling a metal strip about said tube.

18. A method according to claim 17 including the step of adhering said strip to said tube.

19. A method according to claim 16 including the step of elongating said tube as said fiber is inserted and subsequently relaxing said tube to provide an excess length of said optic fiber in said tube.
